(19) United States
(12) Patent Application Publication
(10) Pub. No.: US 2015/0023574 A1
(43) Pub. Date: Jan. 22, 2015

(54) APPARATUS FOR PROVIDING MEDICAL IMAGE KNOWLEDGE SERVICE AND IMAGE PROCESSING DEVICE AND METHOD FOR THE SAME

(71) Applicant: ELECTRONICS AND TELECOMMUNICATIONS RESEARCH INSTITUTE, Daejeon-city (KR)

(72) Inventors: Sung-Won SOHN, Daejeon (KR); Jong-Hyun PARK, Daejeon (KR); Sung-Woong SHIN, Daejeon (KR); Hyo-Bong HONG, Daejeon (KR); Min-Soo KIM, Sejong (KR); In-Sung JANG, Sejong (KR); Young-Ho SUH, Daejeon (KR); Chung-Ho LEE, Daejeon (KR); Jae-Ho LIM, Daejeon (KR); Sang-Keun RHEE, Daejeon (KR); Jae-Chul KIM, Daejeon (KR)

(21) Appl. No.: 14/331,573

(22) Filed: Jul. 15, 2014

(30) Foreign Application Priority Data
Jul. 17, 2013 (KR) 10-2013-0083994
Feb. 25, 2014 (KR) 10-2014-0022143

(51) Int. Cl. G06T 7/00; G06K 9/46

(52) U.S. Cl. CPC G06T 7/0014; G06K 9/4604; G06T 2207/10088
USPC 382/131

(57) ABSTRACT

Disclosed herein is technology for providing a medical image knowledge service. An apparatus for providing a medical image knowledge service according to an embodiment includes an image processing device for acquiring image information of at least a partial region of an analysis target based on a distribution of reactive oxygen species or magnetic particles, and generating final image information of an overall region of the analysis target based on results of analysis of the acquired image information. A medical knowledge service device constructs a medical knowledge model based on the acquired final image information, and provides a medical image knowledge service to a user using the constructed medical knowledge model.

### CROSS REFERENCE TO RELATED APPLICATIONS

This application claims the benefit of Korean Patent Application Nos. 10-2013-0083994, filed on Jul. 17, 2013 and 10-2014-0022143, filed on Feb. 25, 2014, which are hereby incorporated by reference in their entirety into this application.

### BACKGROUND OF THE INVENTION

1. Technical Field

The present invention relates generally to an apparatus for providing a medical image knowledge service and an image processing device and method for the service provision apparatus and, more particularly, to technology for acquiring images based on reactive oxygen species or magnetic particles and providing a medical image knowledge service using the acquired images.

2. Description of the Related Art

As technology for acquiring image data using a complex electromagnetic field and nonlinear magnetic signals, technology for acquiring image data using an electromagnetic field, radiation, and ultrasonic waves is generally well known. Conventional technologies using an electromagnetic field may be classified into Nuclear Magnetic Resonance (NMR) for acquiring image data by resonating an atomic nucleus using a magnetic field and high frequencies, and Electro Spin Resonance (ESR) using the resonance of electrons. Methods using radiation include an X-ray scheme including Computer Tomography (CT), and a Positron Emission Tomography (PET) scheme. The X-ray scheme is a scheme for emitting X-rays, and the PET scheme is a method of analyzing positrons emitted from a radioactive material and denotes technology for measuring physical/chemical signals for a measurement material and then implementing an image. The scheme using ultrasonic waves, which is a method of radiating ultrasonic waves onto a specific region and acquiring internal images of a body using reflected signals, is chiefly used to acquire an image of a specific region rather than an overall region of a body. Korean Patent Application Publication No. 10-2007-0082138 discloses technology related to a medical image storage and transmission system and method for providing various medical images.

### SUMMARY OF THE INVENTION

Accordingly, the present invention has been made keeping in mind the above problems occurring in the prior art, and an object of the present invention is to provide an image processing device and method, which acquire image data based on the distribution of magnetic particles or reactive oxygen species, and create image data integrated with existing medical image data.

Another object of the present invention is to provide an apparatus for providing a medical image knowledge service, which constructs a medical knowledge model based on integrated image data acquired by the image processing device, and provides a medical image knowledge service using the constructed medical knowledge model.

In accordance with an aspect of the present invention to accomplish the above objects, there is provided an image processing device, including an image acquisition unit for acquiring information about a first image of at least a partial region of an analysis target based on a distribution of reactive oxygen species or magnetic particles, an image analysis unit for, if the first image information is acquired, analyzing the first image information, and an image generation unit for generating final image information of an overall region of the analysis target based on results of the analysis.

Preferably, the image analysis unit analyzes the first image information and determines a location with respect to the first image in a predefined coordinate system.

Preferably, the image analysis unit may determine locations of the reactive oxygen species or magnetic particles in the predefined coordinate system via time tagging, and then determine the location with respect to the first image.

Preferably, the image generation unit may register the first image information to information about a second image previously acquired from the overall region of the analysis target based on the determined location with respect to the first image, and then generate the final image information.

Preferably, the image analysis unit may analyze the second image information, and determine a location with respect to the second image in the predefined coordinate system, and the image generation unit may register the first image information to the second image information based on the location with respect to the first image and the location with respect to the second image.

Preferably, the second image information may include any one of a Magnetic Resonance Imaging (MRI) image, a Computer Tomography (CT) image, and a Positron Emission Tomography (PET) image.

Preferably, the image analysis unit may analyze the first image information, and extracts feature data from at least a partial region of the analysis target, and the image generation unit may register the first image information to information about a second image previously acquired from the overall region of the analysis target, based on the extracted feature data, and then generate the final image information.

In accordance with another aspect of the present invention to accomplish the above objects, there is provided an image processing method, including acquiring information about a first image of at least a partial region of an analysis target based on a distribution of reactive oxygen species or magnetic particles, if the first image information is acquired, analyzing the first image information, and generating final image information of an overall region of the analysis target based on results of the analysis.

Preferably, analyzing the first image information may be configured to analyze the first image information and determine a location with respect to the first image in a predefined coordinate system.

Preferably, analyzing the first image information may be configured to determine locations of the reactive oxygen species or magnetic particles in the predefined coordinate system via time tagging, and then determine the location with respect to the first image.

Preferably, generating the final image information may include registering the first image information to information about a second image previously acquired from the overall region of the analysis target based on the determined location with respect to the first image.

Preferably, the image processing method may further include analyzing the second image information, and determining a location with respect to the second image in the predefined coordinate system, wherein registering the first image information to the second image information is configured to register the first image information to the second image information based on the location with respect to the first image and the location with respect to the second image.

Preferably, the second image information may include any one of a Magnetic Resonance Imaging (MRI) image, a Computer Tomography (CT) image, and a Positron Emission Tomography (PET) image.

Preferably, analyzing the first image information may be configured to analyze the first image information and extract feature data from at least a partial region of the analysis target, and generating the final image information may include registering the first image information to information about a second image previously acquired from the overall region of the analysis target, based on the extracted feature data.

In accordance with a further aspect of the present invention to accomplish the above objects, there is provided an apparatus for providing a medical image knowledge service, including an image processing device for acquiring image information of at least a partial region of an analysis target based on a distribution of reactive oxygen species or magnetic particles, and generating final image information of an overall region of the analysis target based on results of analysis of the acquired image information, and a medical knowledge service device for constructing a medical knowledge model based on the acquired final image information, and providing a medical image knowledge service to a user using the constructed medical knowledge model.

Preferably, the medical knowledge service device may construct the medical knowledge model by associating the generated final image information with clinical knowledge information.

Preferably, the medical knowledge service device may discover a relation pattern between image features and diseases based on the final image information and the clinical knowledge information, and construct the medical knowledge model by analyzing and learning the relation pattern.

Preferably, the medical knowledge service device may diagnose lesions or predict prognosis of diseases for respective final images or respective patients using the constructed medical knowledge model, and provide results of diagnose or prediction to a user who requests the results.

### BRIEF DESCRIPTION OF THE DRAWINGS

FIG. 1 is a diagram showing examples of services provided by an apparatus for providing a medical image knowledge service according to an embodiment;

FIG. 2 is a configuration diagram of an apparatus for providing a medical image knowledge service according to an embodiment;

FIG. 3 is a block diagram showing the apparatus for providing a medical image knowledge service according to an embodiment;

FIG. 4 is a block diagram showing the image processing device of the apparatus for providing a medical image knowledge service shown in FIG. 3;

FIGS. 5 to 10 are exemplary diagrams showing the image processing device of FIG. 4;

FIG. 11 is a block diagram showing the medical knowledge service device of the apparatus for providing a medical image knowledge service shown in FIG. 3;

FIGS. 12 to 16 are exemplary diagrams illustrating the medical knowledge service device of FIG. 11;

FIG. 17 is a flowchart showing an image processing method performed by the image processing device according to an embodiment; and

FIG. 18 is a flowchart showing a medical image knowledge service method performed by the medical knowledge service device according to an embodiment.

### DESCRIPTION OF THE PREFERRED EMBODIMENTS

Details of other embodiments are included in detailed description and attached drawings. The features and advantages of technology disclosed in the present invention and methods for achieving them will be more clearly understood from detailed description of the following embodiments taken in conjunction with the accompanying drawings. Reference now should be made to the drawings, in which the same reference numerals are used throughout the different drawings to designate the same or similar components.

Hereinafter, embodiments of an apparatus for providing a medical image knowledge service, and an image processing device and method for the service provision apparatus according to the present invention will be described in detail with reference to the attached drawings.

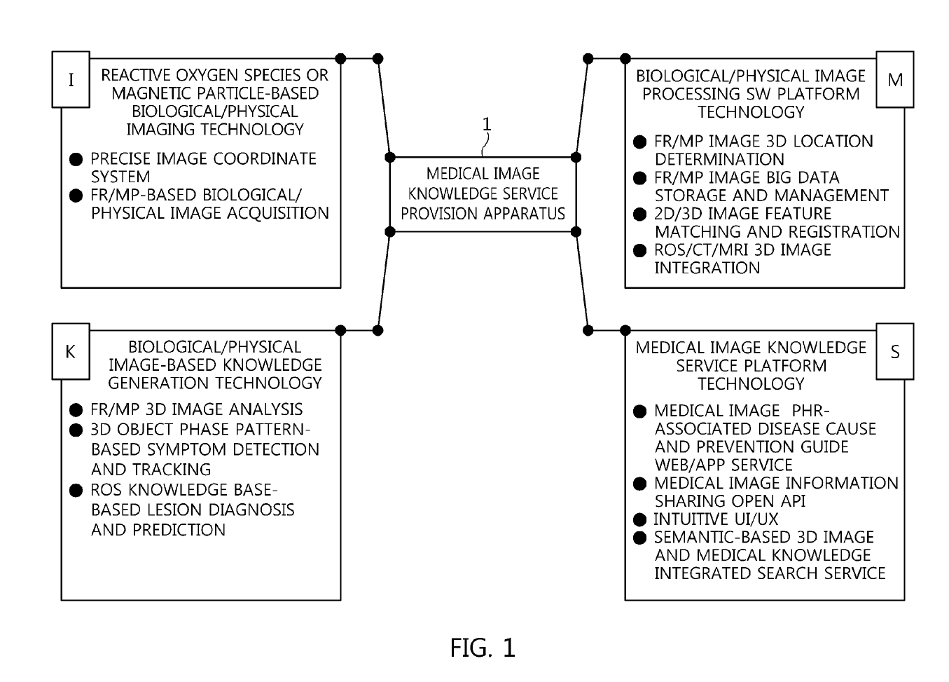

FIG. 1 illustrates examples of services provided by an apparatus for providing a medical image knowledge service according to an embodiment.

As shown in FIG. 1, in the embodiment, an apparatus 1 for providing a medical image knowledge service may chiefly provide services related to four types of technologies (I, M, K, and S).

That is, first technology I relates to technology for acquiring biological/physical images using a hardware device, and is configured to acquire Free Radical (FR)/Magnetic Particle (MP)-based biological/physical images using a precise image coordinate system and then provide a medical image knowledge service using the acquired images.

Second technology M relates to technology for processing the acquired biological/physical images, and is configured to, if images are acquired by technology I, determine three-dimensional (3D) locations of the acquired images, perform registration between the images based on the determined locations, and then generate required medical images as a result of the registration. In this case, the registered images may be existing MRI/CT images as well as the images acquired by technology I. Further, the images may be registered to each other by extracting pieces of feature data from two-dimensional/three-dimensional (2D/3D) images and matching the feature data with each other. The 2D images acquired by technology I are converted into 3D images, and 2D/3D images may be stored and managed in a database (DB).

Third technology K relates to technology for constructing a knowledge model based on the medical images generated by technology M, and is configured to analyze FR/MP-based medical images generated by technology M, construct a medical knowledge model by detecting and tracking a symptom, and diagnose and predict lesions using the medical knowledge model. In this technology K, in order to generate information useful for the diagnosis of an actual disease using the acquired images, the medical knowledge model may be constructed medical by integrating existing medical data or the opinions of medical teams.

Fourth technology S relates to technology for providing various medical image knowledge services based on the constructed medical knowledge model, and is configured to provide constructed medical images or Personal Health Records (PHRs) to a system associated through an Open Application Programming Interface (API), for example, a hospital, or provide a prevention guide web/Application (App) service. Further, such technology may provide a semantic-based 3D image and medical knowledge-integrated search service, and provide an intuitive interface to a user for the service.

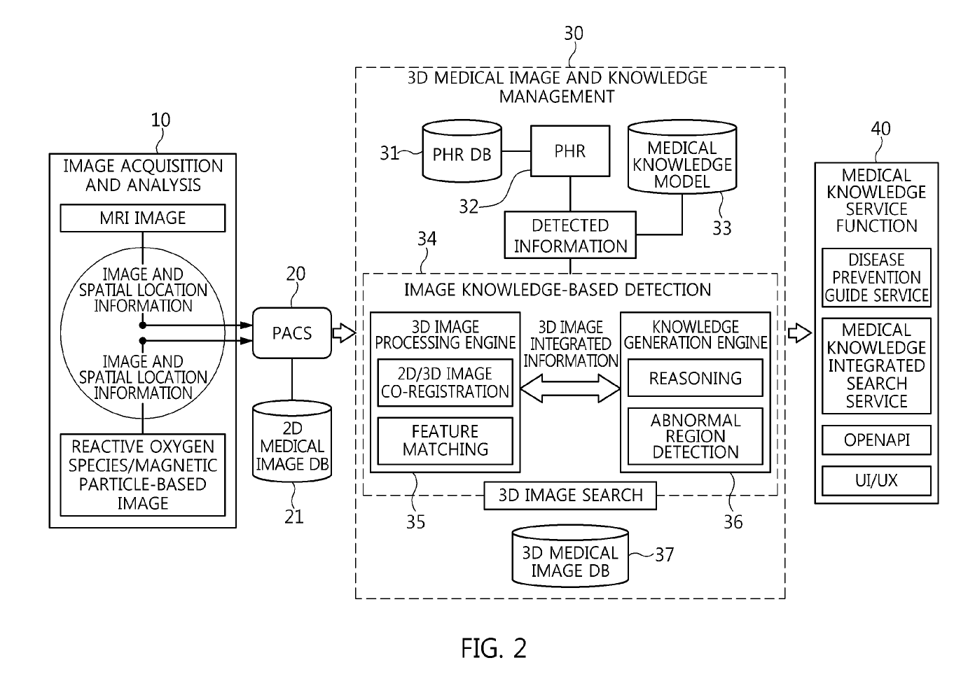

FIG. 2 is a configuration diagram of an apparatus for providing a medical image knowledge service according to an embodiment.

Referring to FIG. 2, a medical image knowledge service provision apparatus 1, which can provide various technology-related services such as those shown in FIG. 1, may include an image acquisition and analysis function 10, a 3D medical image and knowledge management function 30, and a medical knowledge service function 40.

As shown in the drawing, the image acquisition and analysis function 10 is associated with technology I and M described in FIG. 1, and is configured to acquire reactive oxygen species/magnetic particle-based images in accordance with an embodiment of the present invention, acquire spatial location information from the acquired reactive oxygen species/magnetic particle-based images and images acquired by a typical MRI scanner or the like, and transfer the spatial location information to the 3D medical image and knowledge management function 30. In this case, the spatial location information may be transferred to the 3D medical image and knowledge management function 30 through a typical Picture Archiving Communication System (PACS) 20 or Digital Imaging and Communications in Medicine (DICOM). As shown in the drawing, the PACS 20 may store the medical image information or the like received from the image acquisition and analysis function 10 in a medical image database (DB) 21.

The 3D medical image and knowledge management function 30 may process the medical images received from the image acquisition and analysis function 10 using a 3D image processing engine 35 included in an image knowledge-based detection function 34, and store and manage the processed medical images in the 3D medical image DB 37. Further, based on the medical images stored in a 3D medical image DB 37, reasoning and the detection of an abnormal region are performed by the knowledge creation engine 36, and then a medical knowledge model 33 may be constructed by integrating the results of the performed detection, Personal Health Record (PHR) information stored in a PHR DB 31, the opinions of a medical team, etc.

Once the medical knowledge model 33 is constructed in this way, the medical knowledge service function 40 may provide a disease prevention guide, a medical knowledge integrated search service, etc. using the medical knowledge model 33.

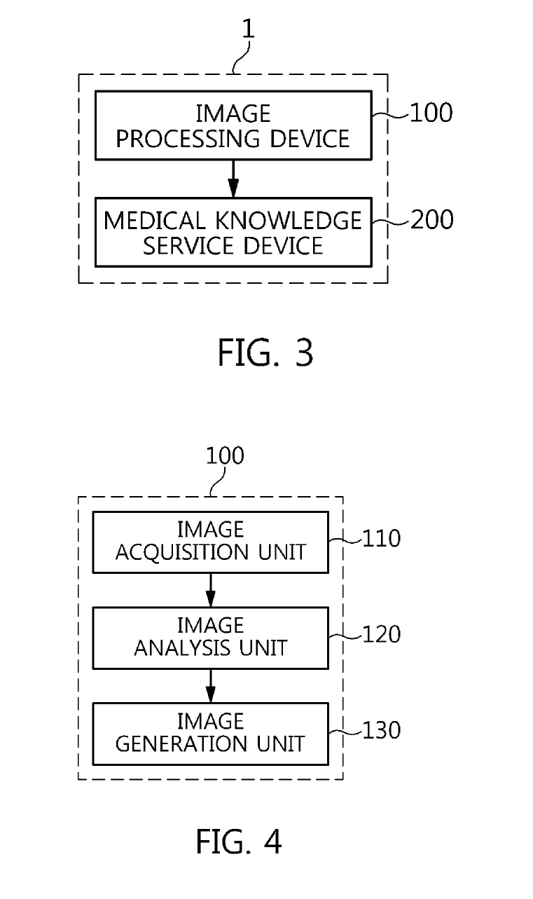

FIG. 3 is a block diagram showing an apparatus for providing a medical image knowledge service according to an embodiment.

Referring to FIG. 3, a medical image knowledge service provision apparatus 1 according to an embodiment may include an image processing device 100 and a medical knowledge service device 200.

An image processing device 100 may acquire reactive oxygen species/magnetic particle-based images, process the acquired images, and generate a final medical image. In this case, the image processing device 100 is associated with technology I and M shown in FIG. 1, and may perform the detailed functions of the image acquisition and analysis function 10 and the detailed function of the 3D image processing engine 35 of the 3D medical image and knowledge management function 30.

The medical knowledge service device 200 may construct a medical knowledge model using the final image generated by the image processing device 100 and provide a medical knowledge service using the constructed medical knowledge model. In this case, the medical knowledge service device 200 is associated with technology K and S shown in FIG. 1, and may perform the detailed functions of the 3D medical image and knowledge management function 30 of FIG. 2 except for the 3D image processing engine 35, and the detailed functions of the medical knowledge service function 40.

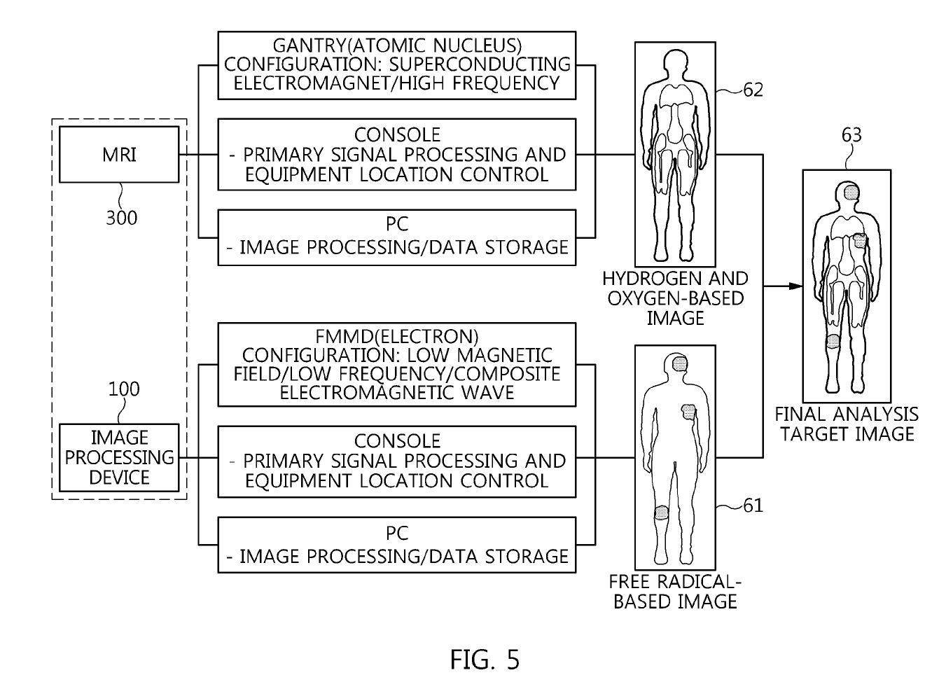

FIG. 4 is a block diagram showing the image processing device 100 of the medical image knowledge service provision apparatus 1 shown in FIG. 3. FIGS. 5 to 10 are exemplary diagrams showing the image processing device of FIG. 4.

Below, the image processing device 100 will be described in greater detail with reference to FIGS. 4 to 10.

Referring to FIG. 4, the image processing device 100 may include, in detail, an image acquisition unit 110, an image analysis unit 120, and an image generation unit 130.

The image acquisition unit 110 may acquire information about a first image of at least a partial region of an analysis target based on the distribution of reactive oxygen species or magnetic particles according to the present embodiment. For example, as shown in FIG. 5, when an analysis target is a body, the image acquisition unit 110 may acquire a first image 61 of a partial region of the body, such as the knee, armpit, or head.

If the first image is acquired by the image acquisition unit 110, the image analysis unit 120 may analyze the first image.

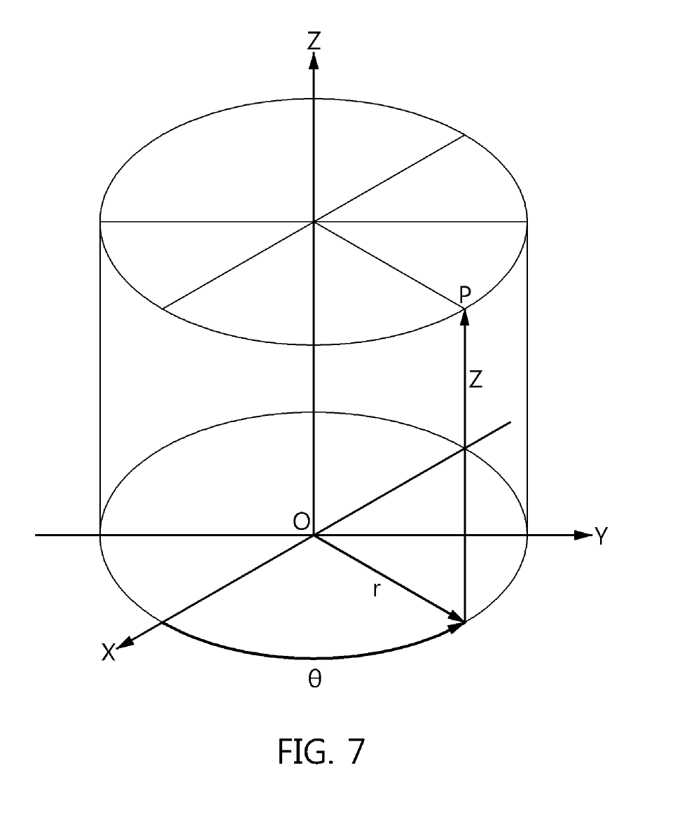

For example, the image analysis unit 120 may obtain the spatial location information of the first image using a precise image coordinate system such as that shown in FIG. 7. For this, a precise image coordinate system having reference point information within a range of 1 mm may be previously constructed. Here, the precise image coordinate system may be a 3D coordinate system.

Further, the image analysis unit 120 may obtain the spatial location information of a second image 62 acquired by a typical imaging device such as an MRI scanner 300. In this case, the second image 62 may be an image acquired via well-known various techniques such as MRI, CT, or Position Emission Tomography (PET).

In this case, the spatial location information of the image 62 acquired by the MRI scanner 300 or the like may be obtained using the above-described precise image coordinate system, but the image coordinate system is not limited thereto, and any type of coordinate system different from the previously constructed precise image coordinate system may also be used.

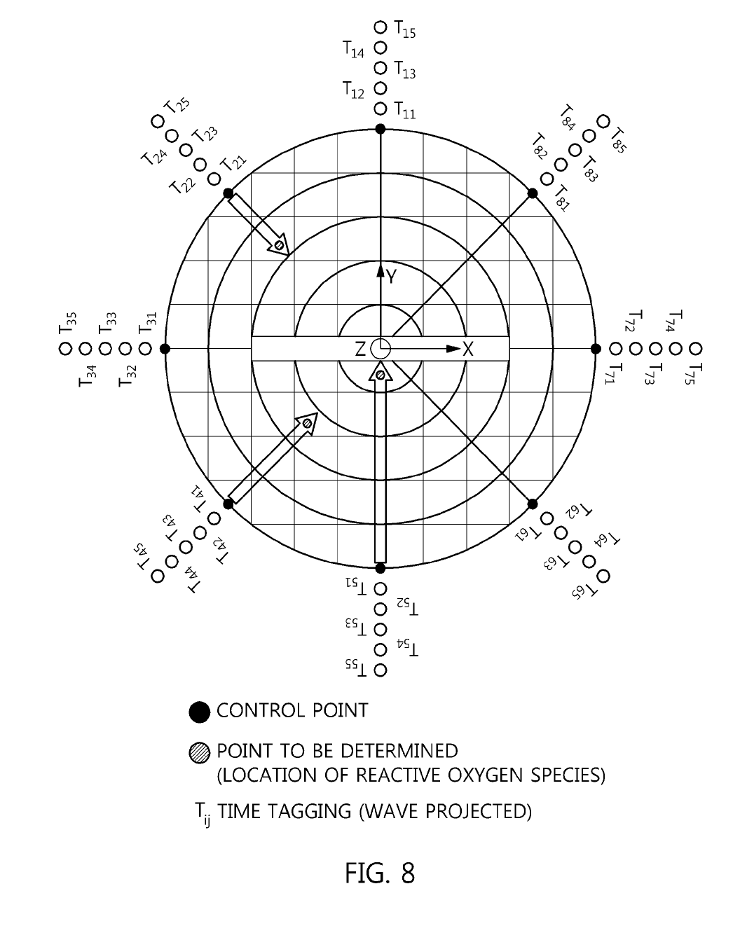

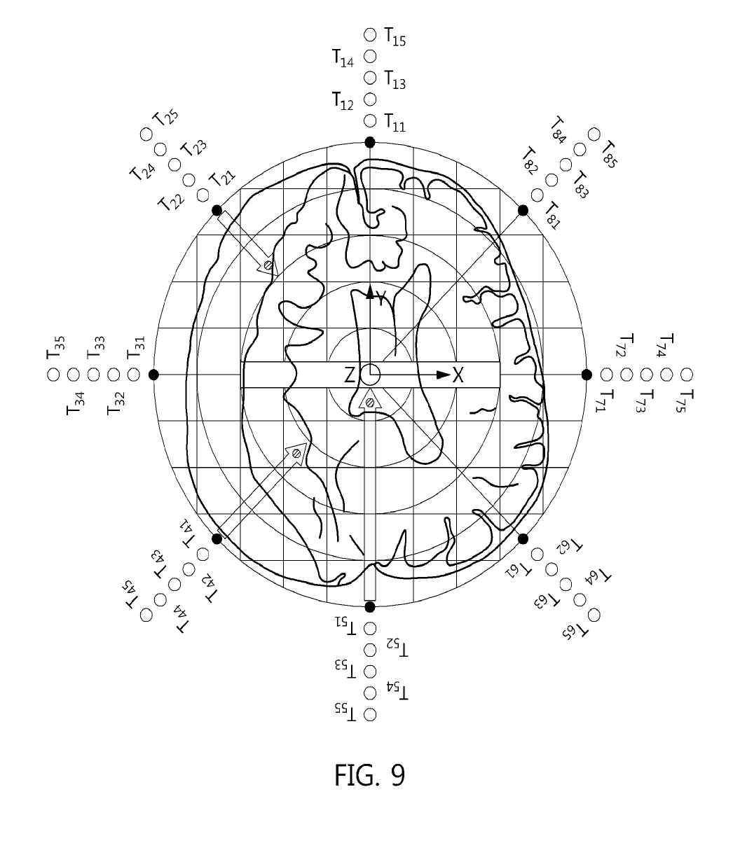

In this case, the image analysis unit 120 may acquire the spatial location information of the first image by determining the locations of reactive oxygen species or magnetic particles, obtained as shown in FIG. 9, using a virtual coordinate system required to apply a time tagging technique as shown in FIG. 8. That is, by means of information about times at which waves are projected in a wave band in which points to be determined (the locations of reactive oxygen species) are detected, spatial location may be estimated.

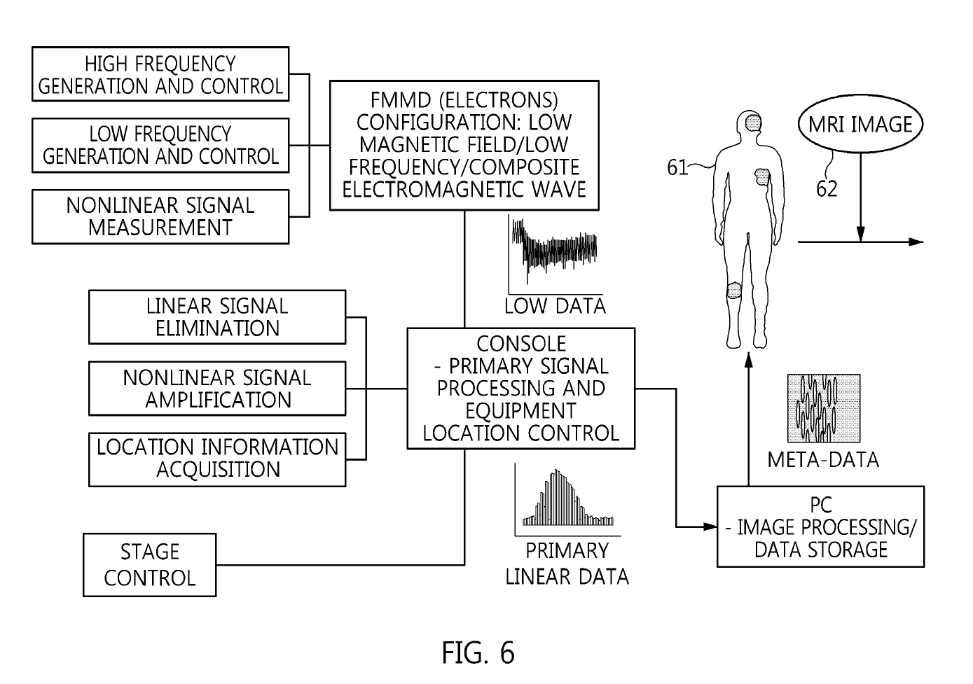

The image generation unit 130 may generate final image information of the overall region of the analysis target based on the results of the analysis by the image analysis unit 120. For example, as shown in FIGS. 5 and 6, the image generation unit 130 may register the first image 61 and the second image 62 to each other based on pieces of spatial location information acquired for the free radical-based first image 61 of the partial region of the analysis target acquired by the image acquisition unit 110 and for the second image 62 of the overall region of the analysis target acquired by the MRI scanner 300 or the like, and thus generate the final image 63 of the overall region of the analysis target.

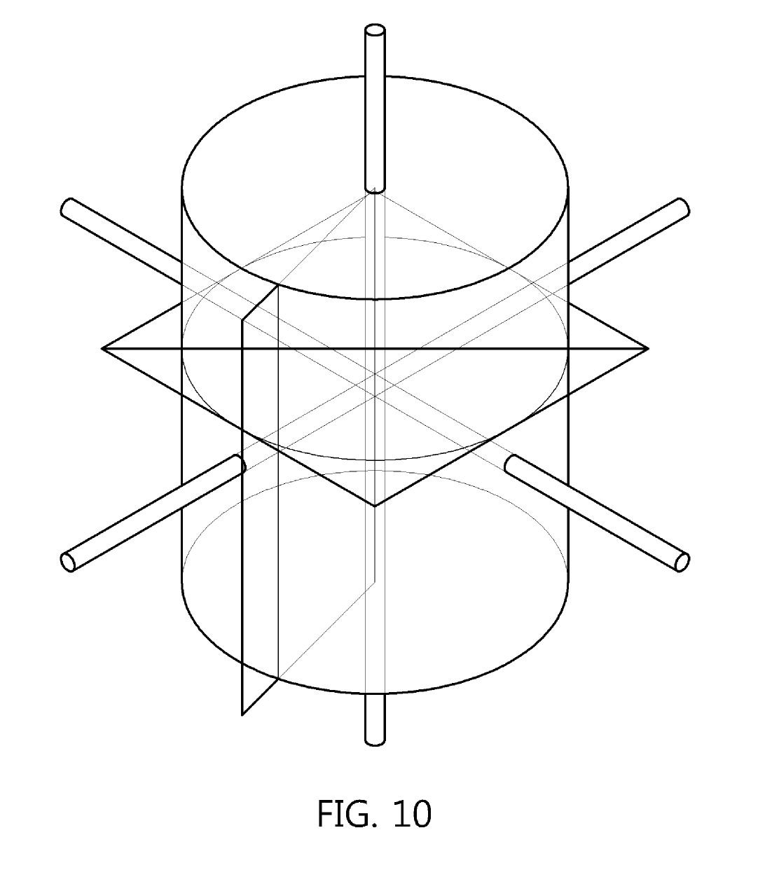

In this case, when the coordinate system of the second image 62 acquired by the MRI scanner 300 or the like and the coordinate system of the first image 61 acquired by the image acquisition unit 110 are heterogeneous coordinate systems, the image generation unit 130 may register the images by means of automatic conversion between the heterogeneous coordinate systems, as shown in FIG. 10. In this case, as a technique for automatically converting heterogeneous coordinate systems, any type of well-known technique may be used.

Meanwhile, in accordance with another embodiment, if the first image 61 is acquired, the image analysis unit 120 may analyze information of the first image and then extract feature data from at least a partial region of the analysis target.

If the feature data is extracted by the image analysis unit 120, the image generation unit 130 may register the first image information to the second image information using the extracted feature data, and then generate final image information.

The image generation unit 130 may generate a 3D medical image by applying the acquired 2D images to the 3D precise image coordinate system, and may store the 3D medical image in the 3D medical image DB 37 such as that shown in FIG. 2. In this case, medical images which are generated based on various criteria, such as for respective persons or respective diseases, may be classified and managed in the 3D medical image DB 37.

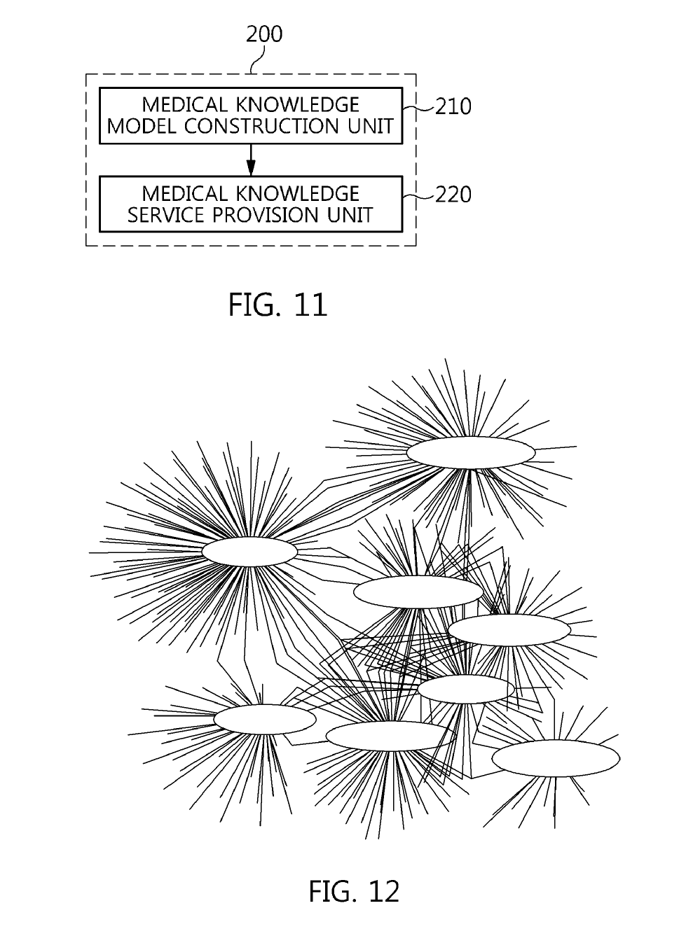

FIG. 11 is a block diagram showing the configuration of the medical knowledge service device in the medical image knowledge service provision apparatus shown in FIG. 3. FIGS. 12 to 16 are exemplary diagrams illustrating the medical knowledge service device of FIG. 11.

Referring to FIG. 11, the medical knowledge service device 200 may include a medical knowledge model construction unit 210 and a medical knowledge service provision unit 220.

If the final image of the analysis target is generated by the image processing device 100, the medical knowledge model construction unit 210 may construct a medical knowledge model based on the information of the generated final image.

For example, the medical knowledge model construction unit 210 may construct a medical knowledge model 33 using image information stored as 3D medical images and Personal Health Record (PHR) information, as shown in FIG. 2. In this case, although not shown in the drawing, it is possible to additionally provide an interface allowing users such as a medical team to receive opinions such as medical treatment-related comments for patients to the users and to integrate various types of opinion information input by the users through the interface, thus constructing an integrated medical knowledge model 33.

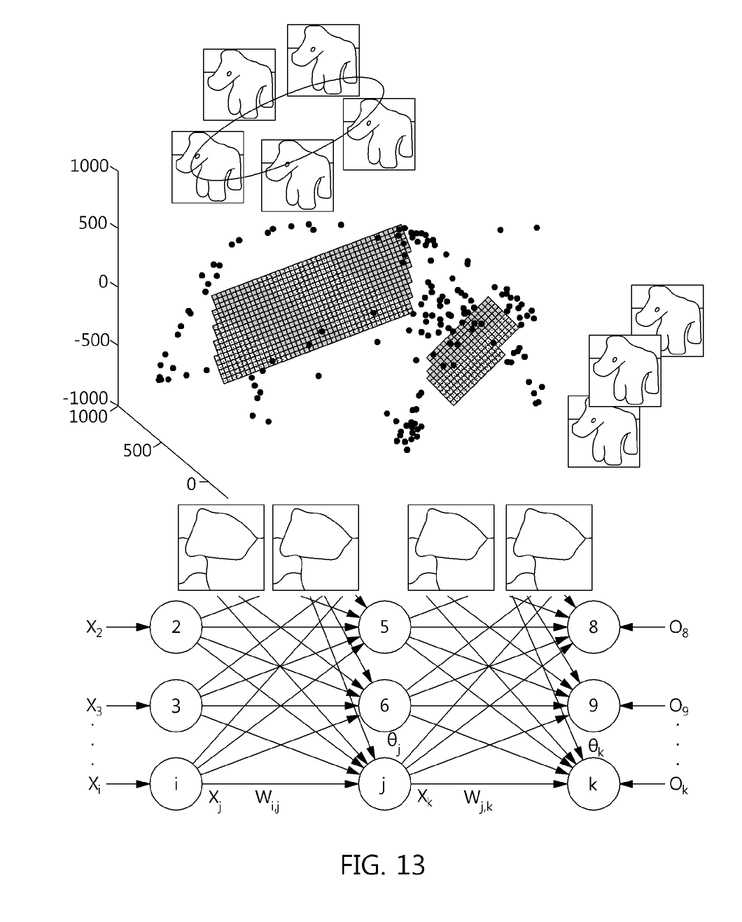

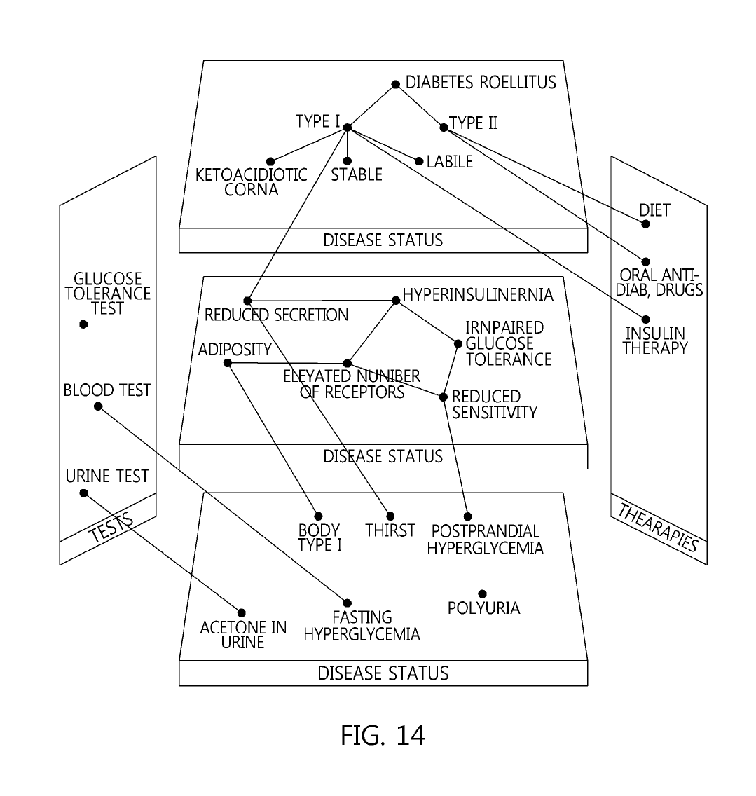

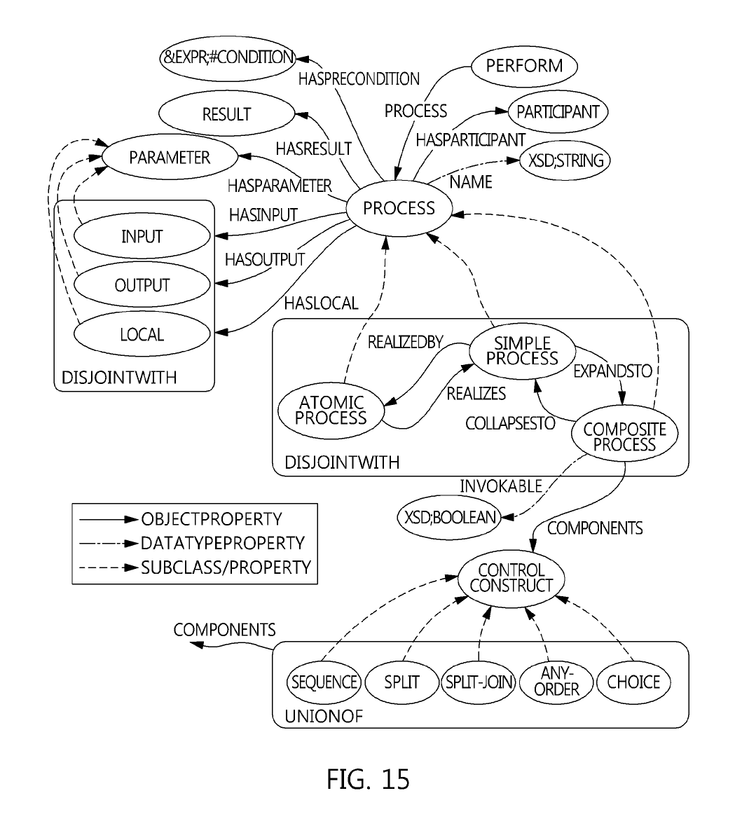

FIG. 12 illustrates an example of the step of modeling the representation of patterns of reactive oxygen species based on clinical information, FIG. 13 illustrates an example of the step of analyzing the patterns of reactive oxygen species and discovering a relation pattern between the features of an acquired image and a disease, FIG. 14 illustrates an example of the step of implementing medical information as knowledge via association between reactive oxygen species and clinical knowledge, and FIG. 15 illustrates an example of a reactive oxygen species-based knowledge reasoning step, which shows an example of the step of diagnosing and predicting lesions for respective images/persons.

As shown in FIGS. 12 to 15, the medical knowledge model construction unit 210 may discover relation patterns between image features and diseases based on the generated final image information and clinical knowledge information, for example, PHR information and opinion information such as users' medical treatment-related comments, and may construct a medical knowledge model by analyzing and learning the discovered relation patterns. Further, the medical knowledge model construction unit 210 may diagnose lesions or predict the prognosis of diseases for respective final images or patients using the constructed medical knowledge model, learn the results of the diagnosis and prediction, and then construct a new medical knowledge model.

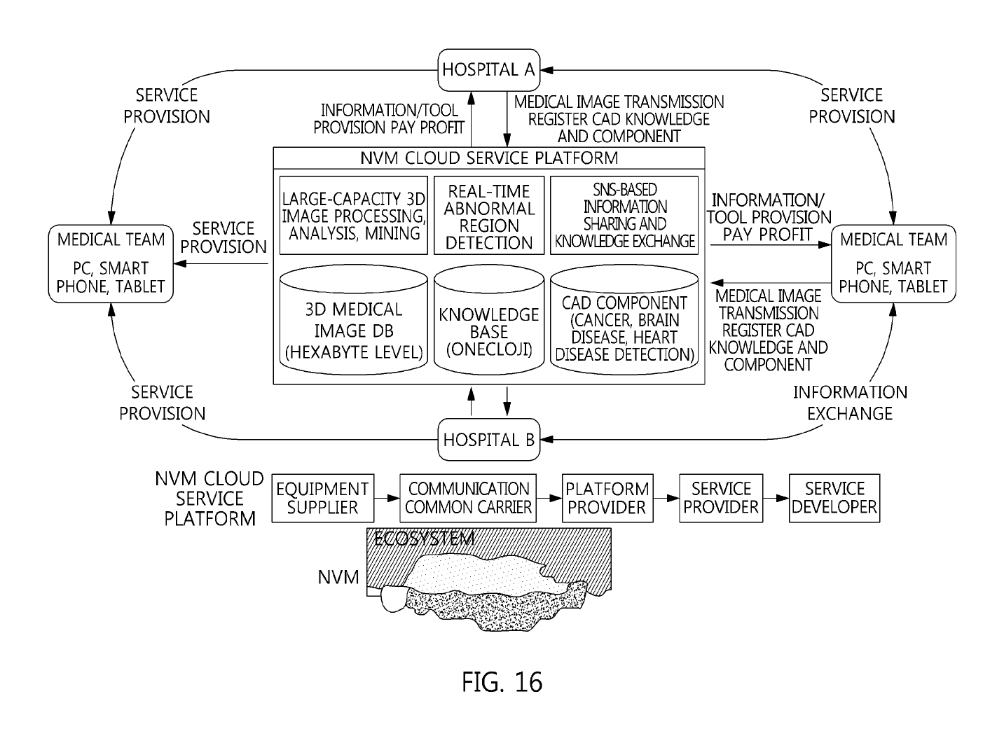

The medical knowledge service provision unit 220 may provide various types of services using the constructed model. For example, FIG. 16 illustrates an example of a platform constructed to provide a medical knowledge service according to an embodiment. As shown in the drawing, the medical knowledge service provision unit 220 may construct a cloud service platform and provide a medical knowledge service to associated hospitals, medical teams, or medical researchers through the platform.

That is, the medical knowledge service provision unit 220 may provide an Open API to an associated hospital system, and if a request from the hospital system is received through the API, may provide various types of information meeting the request, for example, 2D/3D medical images, disease analysis, prognosis prediction records, PHR information, etc. Further, the medical knowledge service provision unit 220 may provide a required interface to the terminal of a medical team or a medical researcher (for example, a Personal Computer (PC), a smart phone, a tablet PC, or the like) and may provide desired information through the interface.

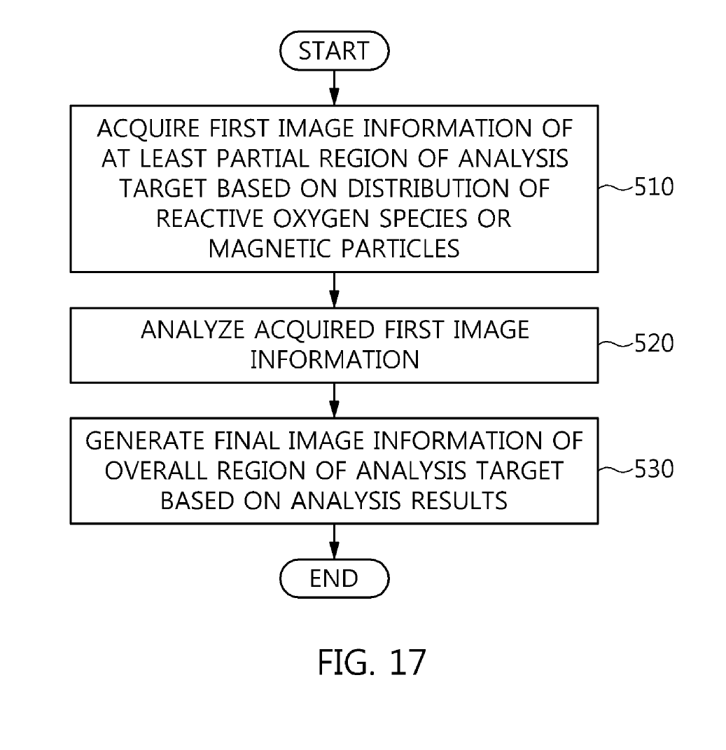

FIG. 17 is a flowchart showing an image processing method performed by the image processing device according to an embodiment.

Referring to FIG. 17, the image processing device may acquire information about a first image of an analysis target based on the distribution of reactive oxygen species or magnetic particles at step 510. In this case, a first image of a partial region of the body desired to be intensively analyzed, such as the knee, armpit, head, or waist, in the overall region of the analysis target, may be acquired.

Next, if the first image is acquired, the first image may be analyzed at step 520. In this case, the spatial location information of the first image may be obtained using a precise image coordinate system. In this case, the precise image coordinate system may be a 3D super-precision image coordinate system having reference point information within a range of 1 mm.

Further, at image analysis step 520, a second image acquired by a typical imaging device, such as an MRI scanner, a CT scanner, or a PET scanner, may be analyzed, and the spatial location information of the second image may be obtained. In this case, the spatial location information of the second image acquired by the typical imaging device may be obtained using the above-described precise image coordinate system, but the image coordinate system is not limited thereto, and any type of coordinate system different from a previously constructed precise image coordinate system may also be used.

Further, image analysis step 520 may be configured to acquire the spatial location information of the image by determining the locations of reactive oxygen species or magnetic particles obtained using a virtual coordinate system required to apply a time tagging technique, as described above with reference to FIGS. 8 and 9.

Then, based on the results of the analysis, final image information of the overall region of the analysis target may be generated at step 530. For example, registration between the first and second images is performed based on the spatial location information obtained for the first and second images, and thus final image information of the overall region of the analysis target may be generated. In this case, when coordinate systems of the first image and the second image are heterogeneous coordinate systems, the heterogeneous coordinate systems are automatically converted, and the images may be registered by means of this automatic conversion.

Meanwhile, according to another embodiment, it is also possible to analyze the first image information, extract feature data from at least a partial region of the analysis target, register the first image information to the second image information using the extracted feature data, and generate final image information.

Further, at image generation step 530, a 3D medical image may be generated by applying acquired 2D images to a 3D precise image coordinate system and may be stored and managed in a 3D medical image DB. Furthermore, generated 3D medical images may be classified and managed depending on various criteria such as for respective persons or diseases.

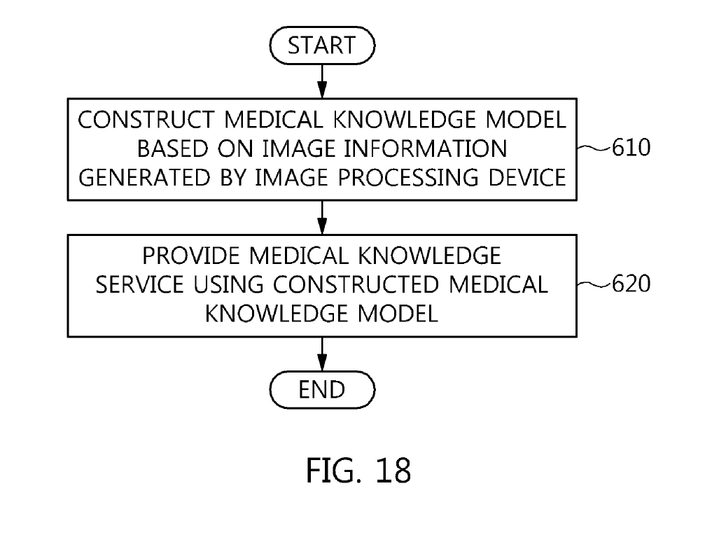

FIG. 18 is a flowchart showing a medical image knowledge service method performed by the medical knowledge service device according to an embodiment.

Referring to FIG. 18, the medical knowledge service device may construct a medical knowledge model based on the final image information generated by the image processing device at step 610. In this case, the medical knowledge service device may discover relation patterns between image features and diseases based on the generated final image information and clinical knowledge information, for example, PHR information and opinion information such as users' medical treatment-related comments, in addition to the medical image information stored and managed in the 3D medical image DB, and may construct a medical knowledge model by analyzing and learning the discovered relation patterns. Further, the medical knowledge service device may diagnose lesions or predict the prognosis of diseases for respective final images or patients using the constructed medical knowledge model, learn the results of the diagnosis and prediction, and then construct a new medical knowledge model.

Next, various medical knowledge services may be provided using the constructed model at step 620.

Step 620 may be configured to construct a cloud service platform, as shown in FIG. 16, and provide the medical knowledge service to an associated hospital, medical team or medical researcher through the platform.

For example, step 620 may be configured to provide an interface to an associated hospital system, and if a request from the hospital system is received through the interface, provide 2D/3D medical images, disease analysis, prognosis prediction records, PHR information, etc. in response to the request. Further, step S620 may be configured to be operated in conjunction with the terminal of a medical team or a medical researcher via the previously provided interface, thus enabling various types of information to be provided to the medical team or medical researcher.

In accordance with the preset invention, medical image information of a target desired to be analyzed may be provided based on the 3D distribution of low frequency and non-radiological material-based magnetic particles, and reactive oxygen species.

In this way, by utilizing reactive oxygen species or magnetic particles, body images may be safely acquired, and cost required for image acquisition may be reduced.

Further, a medical knowledge service is provided to a user such as a medical team by using model information constructed based on image information acquired in this way, thus improving the precision of diagnosis.

Those skilled in the art to which the present embodiments pertain will appreciate that the present invention may be implemented in other detailed forms without changing the technical spirit or essential features of the present invention. Therefore, the above-described embodiments should be understood to be exemplary rather than restrictive in all aspects.

What is claimed is:

1. An image processing device, comprising:
an image acquisition unit for acquiring information about a first image of at least a partial region of an analysis target based on a distribution of reactive oxygen species or magnetic particles;
an image analysis unit for, if the first image information is acquired, analyzing the first image information; and
an image generation unit for generating final image information of an overall region of the analysis target based on results of the analysis.

2. The image processing device of claim 1, wherein the image analysis unit analyzes the first image information and determines a location with respect to the first image in a predefined coordinate system.

3. The image processing device of claim 2, wherein the image analysis unit determines locations of the reactive oxygen species or magnetic particles in the predefined coordinate system via time tagging, and then determines the location with respect to the first image.

4. The image processing device of claim 2, wherein the image generation unit registers the first image information to information about a second image previously acquired from the overall region of the analysis target based on the determined location with respect to the first image, and then generates the final image information.

5. The image processing device of claim 4, wherein:
the image analysis unit analyzes the second image information, and determines a location with respect to the second image in the predefined coordinate system, and
the image generation unit registers the first image information to the second image information based on the location with respect to the first image and the location with respect to the second image.

6. The image processing device of claim 4, wherein the second image information includes any one of a Magnetic Resonance Imaging (MRI) image, a Computer Tomography (CT) image, and a Positron Emission Tomography (PET) image.

7. The image processing device of claim 1, wherein:
the image analysis unit analyzes the first image information, and extracts feature data from at least a partial region of the analysis target, and
the image generation unit registers the first image information to information about a second image previously acquired from the overall region of the analysis target, based on the extracted feature data, and then generates the final image information.

8. An image processing method, comprising:
acquiring information about a first image of at least a partial region of an analysis target based on a distribution of reactive oxygen species or magnetic particles;
if the first image information is acquired, analyzing the first image information; and
generating final image information of an overall region of the analysis target based on results of the analysis.

9. The image processing method of claim 8, wherein analyzing the first image information is configured to analyze the first image information and determine a location with respect to the first image in a predefined coordinate system.

10. The image processing method of claim 9, wherein analyzing the first image information is configured to determine locations of the reactive oxygen species or magnetic particles in the predefined coordinate system via time tagging, and then determine the location with respect to the first image.

11. The image processing method of claim 9, wherein generating the final image information comprises registering the first image information to information about a second image previously acquired from the overall region of the analysis target based on the determined location with respect to the first image.

12. The image processing method of claim 11, further comprising analyzing the second image information, and determining a location with respect to the second image in the predefined coordinate system,
wherein registering the first image information to the second image information is configured to register the first image information to the second image information based on the location with respect to the first image and the location with respect to the second image.

13. The image processing method of claim 11, wherein the second image information includes any one of a Magnetic Resonance Imaging (MRI) image, a Computer Tomography (CT) image, and a Positron Emission Tomography (PET) image.

14. The image processing method of claim 8, wherein:
analyzing the first image information is configured to analyze the first image information and extract feature data from at least a partial region of the analysis target, and
generating the final image information comprises registering the first image information to information about a second image previously acquired from the overall region of the analysis target, based on the extracted feature data.

15. An apparatus for providing a medical image knowledge service, comprising:
an image processing device for acquiring image information of at least a partial region of an analysis target based on a distribution of reactive oxygen species or magnetic particles, and generating final image information of an overall region of the analysis target based on results of analysis of the acquired image information; and
a medical knowledge service device for constructing a medical knowledge model based on the acquired final image information, and providing a medical image knowledge service to a user using the constructed medical knowledge model.

16. The apparatus of claim 15, wherein the medical knowledge service device constructs the medical knowledge model by associating the generated final image information with clinical knowledge information.

17. The apparatus of claim 16, wherein the medical knowledge service device discovers a relation pattern between image features and diseases based on the final image information and the clinical knowledge information, and constructs the medical knowledge model by analyzing and learning the relation pattern.

18. The apparatus of claim 16, wherein the medical knowledge service device diagnoses lesions or predicts prognosis of diseases for respective final images or respective patients using the constructed medical knowledge model, and provides results of diagnose or prediction to a user who requests the results.
